(19) United States
(12) Patent Application Publication
(10) Pub. No.: US 2018/0297531 A1
(43) Pub. Date: Oct. 18, 2018

(54) MOTOR VEHICLE HAVING A LUGGAGE COMPARTMENT COVER

(71) Applicant: FORD GLOBAL TECHNOLOGIES, LLC, Dearborn, MI (US)

(72) Inventors: Matthias Baumann, Aachen (DE); Sascha Kaatz, Langenfeld (DE)

(21) Appl. No.: 15/936,853

(22) Filed: Mar. 27, 2018

(30) Foreign Application Priority Data
Apr. 12, 2017 (DE) 102017206309.2

(51) Int. Cl. B60R 5/04

(52) U.S. Cl. CPC B60R 5/045; B60R 2011/0059

(57) ABSTRACT

A motor vehicle includes a tailgate that can be pivoted up to the rear and to which a luggage compartment cover for a luggage compartment, which is located behind a seat and situated within a passenger compartment, is fastened so as to be pivotable by its rear end region about a pivot axis. The luggage compartment cover is held, at a region spaced apart from the pivot axis, on a vehicle body via at least one force transmission feature which, upon pivoting up of the tailgate, pivots the luggage compartment cover so as to free access to the luggage compartment. The force transmission feature is deflected on a force deflection feature mounted on the tailgate.

### TECHNICAL FIELD

This document relates to a motor vehicle having a luggage compartment cover.

### BACKGROUND

Luggage compartment covers for motor vehicles for covering a luggage compartment, which is located behind a seat of the motor vehicle and situated within a passenger compartment, are generally known. Such luggage compartment covers offer, on the one hand, a visual barrier when the tailgate is closed such that the interior of the luggage compartment cannot be seen from outside with the tailgate closed, and, on the other hand, can also be pivoted at the same time as the tailgate has been pivoted up so as to free access to the luggage compartment, with the result that, with the tailgate opened, objects can be placed in and removed from the luggage compartment without parts of the luggage compartment cover having to be manually removed or moved away. In addition, a closed luggage compartment cover advantageously reduces the transmission of unwanted noises from the luggage compartment or the rear region of the motor vehicle into the passenger cell and thus improves its NVH (Noise, Vibration, Harshness) properties.

It is customary for such luggage compartments covers to have their front end region pivotably mounted on the vehicle body, for example on lateral parts of the luggage compartment in the region of a rear seat backrest upper edge, and to have their rear end region connected to the tailgate via a respective band or cable mounted on each side of the luggage compartment cover, with the result that the tailgate, upon pivoting up to the rear, also upwardly pivots the luggage compartment cover so as thereby to free access to the luggage compartment. Such a luggage compartment cover for a motor vehicle is shown for example in U.S. Pat. No. 8,172,296 B2, the luggage compartment cover here additionally being split into a front cover portion and a rear cover portion in order to increase the access region to the luggage compartment of the motor vehicle and thereby simplify the insertion and removal of relatively large articles into or from the luggage compartment. As described above, the front cover portion of the luggage compartment cover is mounted on the motor vehicle. By contrast, the rear cover portion is fixedly connected to the tailgate such that it moves completely together with the tailgate and adjoins the front cover portion of the luggage compartment cover only in the closed state of the tailgate in such a way that both portions form a single, planar, horizontal surface.

Furthermore, DE 196 04 214 A1 discloses a luggage compartment cover for a motor vehicle which has its rear end region pivotably attached to a tailgate of the motor vehicle and, in the closed state of the tailgate, covers a luggage compartment of the motor vehicle, which is located behind a vehicle seat and situated within a passenger compartment. Upon pivoting up the tailgate to the rear, the luggage compartment cover also pivots up to the rear in order to free access to the luggage compartment. To ensure that, in the opened state of the tailgate, the luggage compartment cover does not simply hang down vertically under the force of gravity, it has its front end region fastened to the vehicle body, for example to the vehicle floor, via a connection means which is elastic in the longitudinal extent thereof and which, in the opened state of the tailgate, pulls the luggage compartment cover, at a certain angle to the vertical direction, in the direction of the passenger compartment in order thereby to increase the access region to the luggage compartment.

### SUMMARY

Against this background, it is an objective to provide a motor vehicle having a luggage compartment cover for a luggage compartment, which is located behind a seat of the motor vehicle and situated within a passenger compartment, which motor vehicle makes available the largest possible access to the luggage compartment with an opened tailgate in order to facilitate the insertion and removal even of large articles into or from the luggage compartment. In addition, the mechanism for freeing and closing access to the luggage compartment should have a design which is as simple as possible and can thus be produced cost-effectively.

This objective is achieved by a motor vehicle having the features of the following claims.

It should be pointed out that the features presented individually in the description below can be combined with one another in any technically expedient manner and demonstrate further embodiments of the motor vehicle. The description additionally characterizes and specifies the motor vehicle in particular in conjunction with the figures.

Accordingly, a motor vehicle has a tailgate which can be pivoted up to the rear and to which a luggage compartment cover for a luggage compartment, which is located behind a seat and situated within a passenger compartment, is fastened so as to be pivotable by its rear end region about a pivot axis. To ensure that the tailgate can be pivoted up to the rear, it can be fastened in a manner known per se at its upper end region to the vehicle body, for example to the vehicle roof, so as to be pivotable about a transverse axis of the vehicle. Furthermore, the luggage compartment cover is held, at a region spaced apart from the pivot axis, on the vehicle body, via at least one force transmission feature which, upon pivoting up of the tailgate, pivots the luggage compartment cover so as to free access to the luggage compartment. According to the motor vehicle, the force transmission feature is deflected on a force deflection feature mounted on the tailgate.

It is thereby ensured that, upon pivoting up of the tailgate, the luggage compartment cover is pulled up toward the tailgate and, after pivoting up of the tailgate, is held substantially completely parallel to the tailgate. The size of the access to the luggage compartment is thus dependent only on the opening angle of the tailgate since, after the tailgate has been completely pivoted up, no region of the luggage compartment cover is arranged to restrict the access region to the luggage compartment. In the closed state of the tailgate, the luggage compartment cover closes access to the luggage compartment completely in a conventional manner such that the interior of the luggage compartment cannot be seen from outside with the tailgate closed. When the tailgate is opened, the largest possible access to the luggage compartment is provided, with the result that the insertion and removal even of large articles into or from the luggage compartment is substantially simplified.

The mechanism for pivoting the luggage compartment cover for freeing and closing access to the luggage compartment can have a very simple design which can be produced cost-effectively, since, on the one hand, the luggage compartment cover is to be only pivotably fastened to the tailgate and, on the other hand, the force transmission feature is to be arranged between the vehicle body and the luggage compartment cover so as to be deflected via force deflection feature mounted on the tailgate, and a connection which holds the luggage compartment cover on the vehicle body is to be provided.

According to an advantageous embodiment, the region of the luggage compartment cover that is spaced apart from the pivot axis and at which the force transmission feature is attached to the luggage compartment cover is a front end region of the luggage compartment cover. Here, the front end region can amount, for example, to approximately ⅓ of the longitudinal extent of the luggage compartment cover in the longitudinal direction of the vehicle or less, preferably for example approximately ¼ and particularly preferably approximately ⅕ of the total longitudinal extent of the luggage compartment cover in the longitudinal direction of the vehicle. In this way, by virtue of the relatively large spacing between the pivot axis of the luggage compartment cover on the tailgate and the attachment point of the force transmission feature on the luggage compartment cover in its front end region, only a small expenditure of force is required on account of the large lever effect in order to pull the luggage compartment cover toward the tailgate when the latter is pivoted up. Accordingly, the force transmission feature can be designed for a small transmission of force and thus be designed in a particularly simple manner.

In addition, it is advantageously possible, through the choice of the attachment point of the force transmission feature on the luggage compartment cover in its front end region, to fix the spacing between the force deflection feature arranged on the tailgate and the attachment point of the force transmission feature on the luggage compartment cover in such a way that this spacing corresponds approximately to the pivoting distance of the force deflection feature arranged and mounted on the tailgate when the tailgate is pivoted up into its opened position, with the result that, after the pivoting-up movement, the luggage compartment cover is held substantially completely parallel to the tailgate. In addition, the arrangement of the force deflection feature along the tailgate can also be chosen within the context of fixing the aforementioned spacing.

A further advantageous embodiment provides that the vehicle body-side attachment of the force transmission feature occurs at a vehicle pillar, for example a C pillar or D pillar, arranged upstream of the tailgate. In this way, the force transmission feature can be guided on a direct route to the force deflection feature without further force deflection feature having to be provided for guiding the force transmission feature from its vehicle body-side attachment point to the tailgate-side force deflection feature. This considerably simplifies the design.

According to a further advantageous embodiment, a still further simplification of the design is obtained by virtue of the fact that the force transmission feature and the force deflection feature are arranged in the passenger compartment and are thus also accessible therefrom. It is thus possible for them to be exchanged easily and without great effort in a maintenance situation, for example. The arrangement of the force transmission feature for example on or along an inner side of the vehicle body surrounding the passenger compartment is also possible in a simple manner and without great effort.

In order, upon pivoting open of the tailgate, to achieve an always identical, defined pivoting movement of the luggage compartment cover that additionally leads to a substantially completely parallel arrangement of the luggage compartment cover to the tailgate after the tailgate has been pivoted up, according to a still further advantageous embodiment the force transmission feature is substantially nonelastic in the force transmission direction.

A still further advantageous embodiment provides that the force transmission feature is designed to transmit only tensile forces. This once again substantially simplifies the design of the motor vehicle with luggage compartment cover since the force transmission feature and the force deflection feature have to be designed only for the transmission or deflection of tensile forces and not additionally also for the transmission or deflection of thrust forces. Thus, the pivoting movement, already described herein, of the luggage compartment cover for freeing access to the luggage compartment during the upward pivoting of the tailgate into its open position can occur by means of a tensile force transmitted by the force transmission feature between the vehicle body and the luggage compartment cover, whereas the pivoting back of the luggage compartment cover for closing access to the luggage compartment during the downward pivoting of the tailgate into its closed position can occur with the aid of the force of gravity acting on the luggage compartment cover. This design can be achieved with simple, cost-effective means.

Thus, in a particularly simple embodiment, the force transmission feature can be a cable or band and the like, for example, which transmits a holding or tensile force between the luggage compartment cover and the vehicle body.

In a further particularly simple and advantageous embodiment, the force deflection feature is an eye or a deflection roller which is arranged or mounted on the tailgate and deflects the force transmission feature, for example a cable, and thus the direction of force channeled by the force transmission feature, in that the force transmission feature is guided through the eye or over the deflection roller.

According to a still further advantageous embodiment, there is respectively provided on each vehicle side of the luggage compartment cover a force transmission feature which is attached to said cover and which is deflected in each case via a force deflection feature mounted laterally on the tailgate. Thus, in this embodiment, there is provided a total of two force transmission feature and two force deflection feature which are each arranged on both sides of the luggage compartment cover in the transverse direction of the vehicle and thus ensure a uniform pivoting movement of the luggage compartment cover when the tailgate is pivoted up and down, without the luggage compartment cover being tilted or twisted in the process.

According to a further advantageous embodiment, the luggage compartment cover is releasably fastened to the tailgate and the force transmission feature is releasably fastened to the luggage compartment cover and/or releasably fastened to the vehicle body. If and as required, it is thus also possible for the luggage compartment cover to be completely removed from the passenger compartment of the motor vehicle. It is particularly advantageous if the releasable fastenings are realized by a suspension mechanism, for example. Thus, the pivotable mounting of the luggage compartment cover on the tailgate can be achieved, for example, by a holding means mounted on the tailgate on both sides of the tailgate in the transverse direction of the vehicle, into each of which holding means there can be received a pivot pin which is mounted on the luggage compartment cover and which defines the pivot axis of the luggage compartment cover.

However, the pivot axis of the luggage compartment cover could also be realized by an elastic, rear end region of the luggage compartment cover which is fixedly connected to the tailgate and which correspondingly elastically bends to pivot the luggage compartment cover. In this case, the elastic, rear end region of the luggage compartment cover could, for example, also be releasably screwed onto or releasably firmly clipped onto the tailgate.

### BRIEF DESCRIPTION OF THE DRAWING FIGURES

Further features and advantages will emerge from the following description of exemplary embodiments which are not to be understood as limiting and which will be explained in more detail hereinbelow with reference to the drawing. In this schematic drawing:

FIG. 1 shows a rear region of a first exemplary embodiment of a motor vehicle having a luggage compartment cover and a closed tailgate;

FIG. 2 shows the rear region of the motor vehicle from FIG. 1, but with the tailgate opened;

FIG. 3 shows a rear-side region of a second exemplary embodiment of a motor vehicle having a luggage compartment cover and an opened tailgate;

FIG. 4 shows a lateral inner view of a right vehicle side of the motor vehicle from FIG. 3 with the tailgate closed; and

FIG. 5 shows a detail view of the rear-side right region of the motor vehicle from FIG. 3 with the tailgate opened.

### DETAILED DESCRIPTION

In the different figures, parts which are equivalent in terms of their function are always provided with the same reference signs, so that as a rule they are only described once.

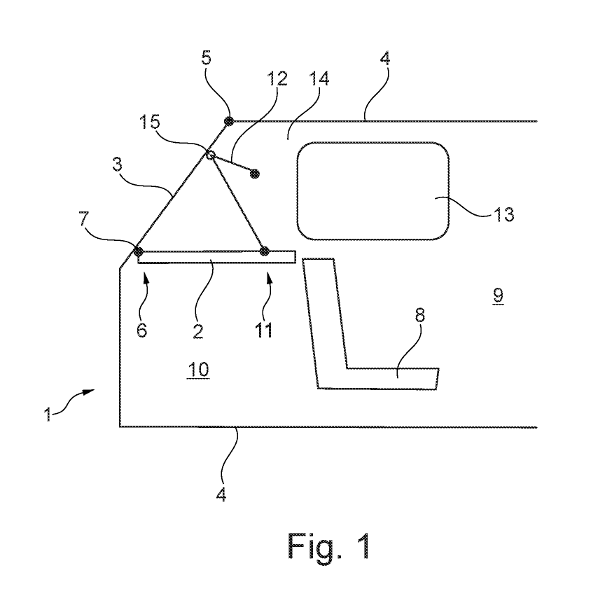

FIG. 1 schematically illustrates a rear region of a first exemplary embodiment of a motor vehicle 1 having a luggage compartment cover 2 and a closed tailgate 3. In particular, FIG. 1 illustrates a schematic cross-sectional side view through the motor vehicle 1 along its center longitudinal plane (corresponds here to the drawing plane). Accordingly, in FIG. 1, the part of the left (with respect to the direction of forward travel) vehicle side is illustrated. The exemplary embodiment of the motor vehicle 1 that is shown here is designed to be substantially symmetrical with respect to the center longitudinal plane in particular in its illustrated rear region, so that parts of the left vehicle side that are described below herein are provided and correspondingly arranged in the same manner also on the right vehicle side, which cannot be seen in FIG. 1.

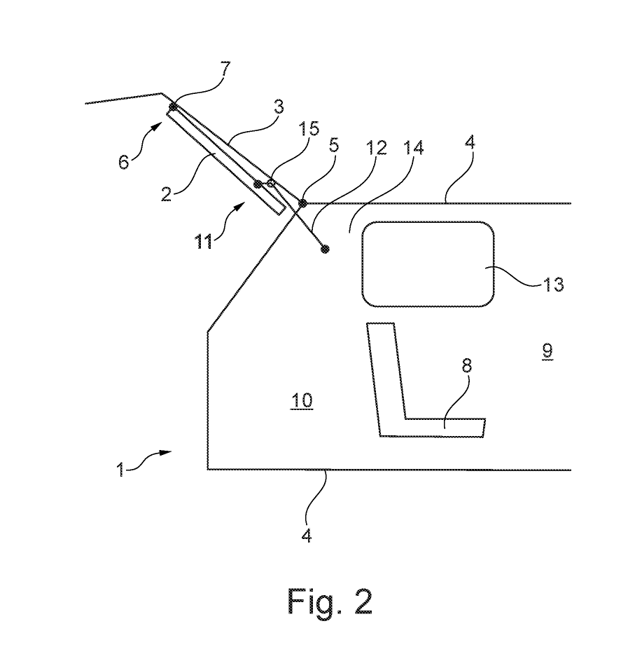

As can be seen from FIG. 1, the tailgate 3 can be pivoted up to the rear about a tailgate pivot axis 5 fixed on a vehicle body 4, in particular on a roof region, (see in this respect also FIG. 2).

It can further be seen from FIG. 1 that the luggage compartment cover 2 has its rear end region 6 fastened to the tailgate 3 so as to be pivotable about a pivot axis 7. In the closed state of the tailgate 3 as illustrated in FIG. 1, the luggage compartment cover 2 conceals access to a luggage compartment 10, which is located behind a seat 8 of the motor vehicle 1, which is here a rear seat of the motor vehicle 1 arranged behind a front sheet (not shown) of the motor vehicle 1, and which is situated within a passenger compartment 9. For this purpose, in the state illustrated in FIG. 1, the luggage compartment cover 2 extends substantially horizontally between its rear end region 6, which is held pivotably on the pivot axis 7, and a rear seat backrest upper edge of the seat 8 which is adjoined by a front end region 11 of the luggage compartment cover 2.

It can further be gathered from FIG. 1 that, in the exemplary embodiments of the motor vehicle 1 that is shown here, the luggage compartment cover 2 is held on the vehicle body 4 at the front end region 11 of the luggage compartment cover 2 spaced apart from the pivot axis 7 via a force transmission feature 12 in the form of a cable which is substantially nonelastic in the force transmission direction and which transmits only tensile forces. In particular, in the case of the motor vehicle 1 illustrated in FIG. 1, the force transmission feature 12 is attached and fastened to the vehicle body 4 at a vehicle pillar 14, here a C pillar of the motor vehicle 1, which is located behind a window 13 and arranged directly upstream of the tailgate.

FIG. 1 further shows a force deflection feature 15 which deflects the force transmission feature 12 and which is arranged and mounted on the tailgate 3. The force deflection feature 15 can be designed, for example, as an eye or as a deflection roller.

FIG. 2 illustrates the rear region of the motor vehicle 1 from FIG. 1 with the tailgate 3 opened. As can be seen here, the tailgate 3 is in a state in which it is pivoted upward to the rear about the tailgate pivot axis 5, the luggage compartment cover 2 being pivoted by the force transmission feature or cable 12 so as to free access to the luggage compartment 10 upon pivoting up of the tailgate 3 and being held in the illustrated state. In order to ensure the largest possible access to the luggage compartment 10, the luggage compartment cover 2, with the tailgate 3 completely opened, is arranged substantially completely parallel to the tailgate 3, as is illustrated in FIG. 2. This is achieved in that the spacing between the force deflection feature 15 in the closed state of the tailgate 3 as illustrated in FIG. 1 and the attachment point of the force transmission feature 12 in the front end region 11 of the luggage compartment cover 2 corresponds approximately to the pivoting distance of the force deflection feature 15 when the tailgate 3 is pivoted up, and therefore the upward pivoting movement of the tailgate 3 and the resultant displacement of the force deflection feature 15 causes said force deflection feature to upwardly pull the force transmission feature 12, which is substantially nonelastic in the force transmission direction and consequently does not lengthen in the force transmission direction, with the result that the front end region 11 of the luggage compartment cover 2 is pivoted about the pivot axis 7 in the direction of the tailgate 3.

Since FIGS. 1 and 2 illustrate only the left vehicle side of the motor vehicle 1, but the motor vehicle 1 is designed substantially symmetrically in particular in its illustrated rear region, it should be understood that, on the right vehicle side not shown in FIGS. 1 and 2, a force transmission feature 12 is likewise attached to the front end region 11 of the right side of the luggage compartment cover 2 and to the right-side vehicle body 4, in particular to the right C pillar 14 of the motor vehicle 1, and the force transmission feature 12 is likewise guided or deflected by a force deflection feature 15 mounted on the right vehicle side of the tailgate 3.

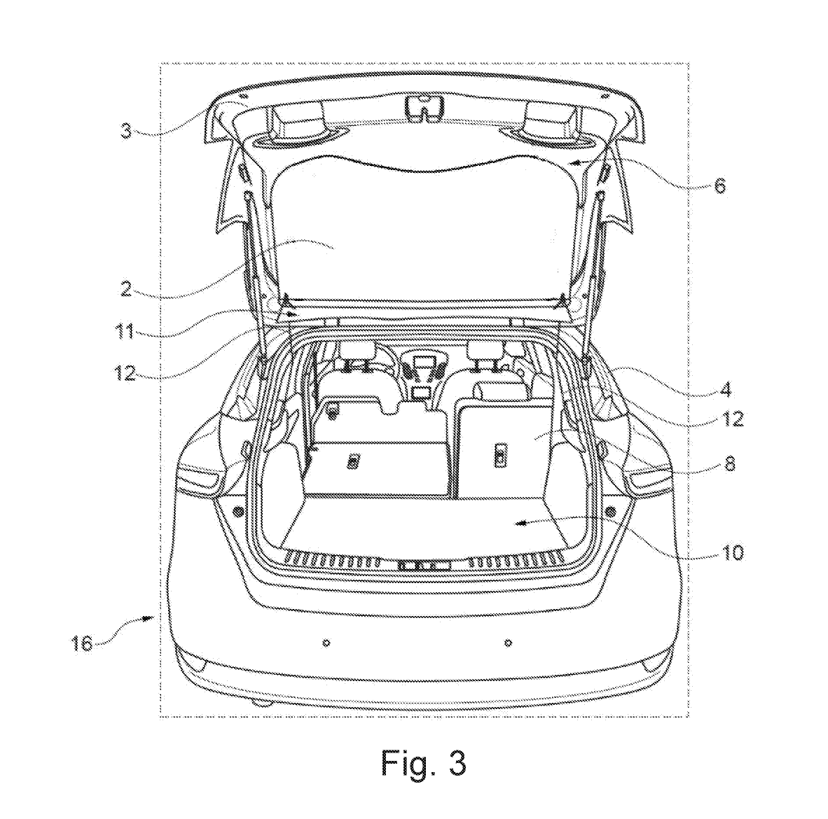

FIG. 3 illustrates a rear-side region of a second exemplary embodiment of a motor vehicle 16 having the luggage compartment cover 2 and opened tailgate 3. The force transmission feature 12 arranged on both sides of the luggage compartment cover 2, which are here likewise designed as cables, can be seen in FIG. 3.

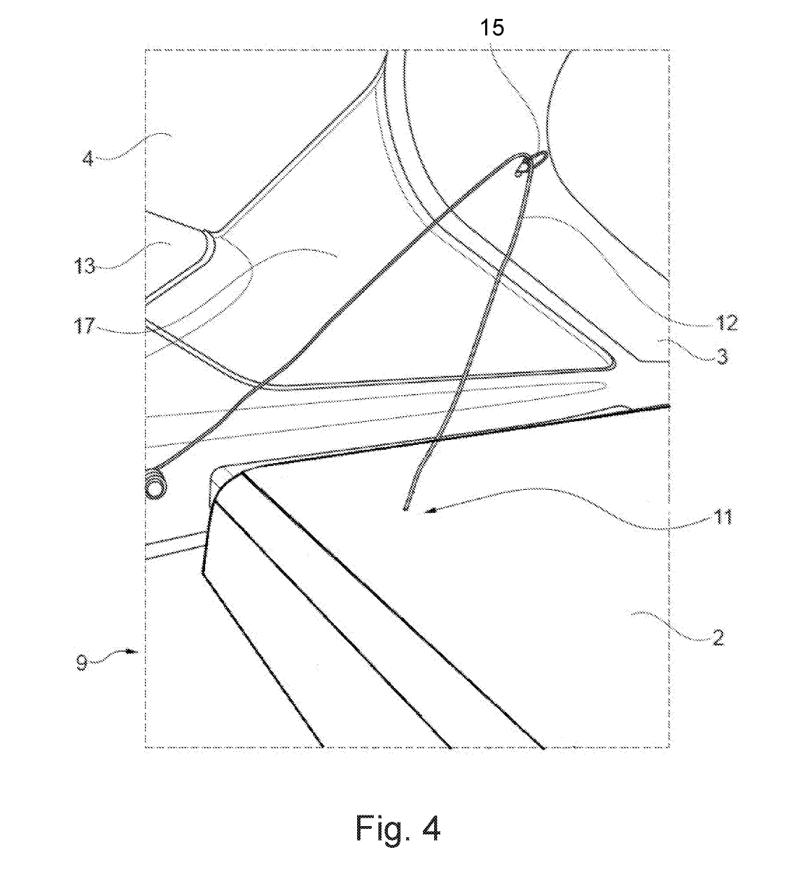

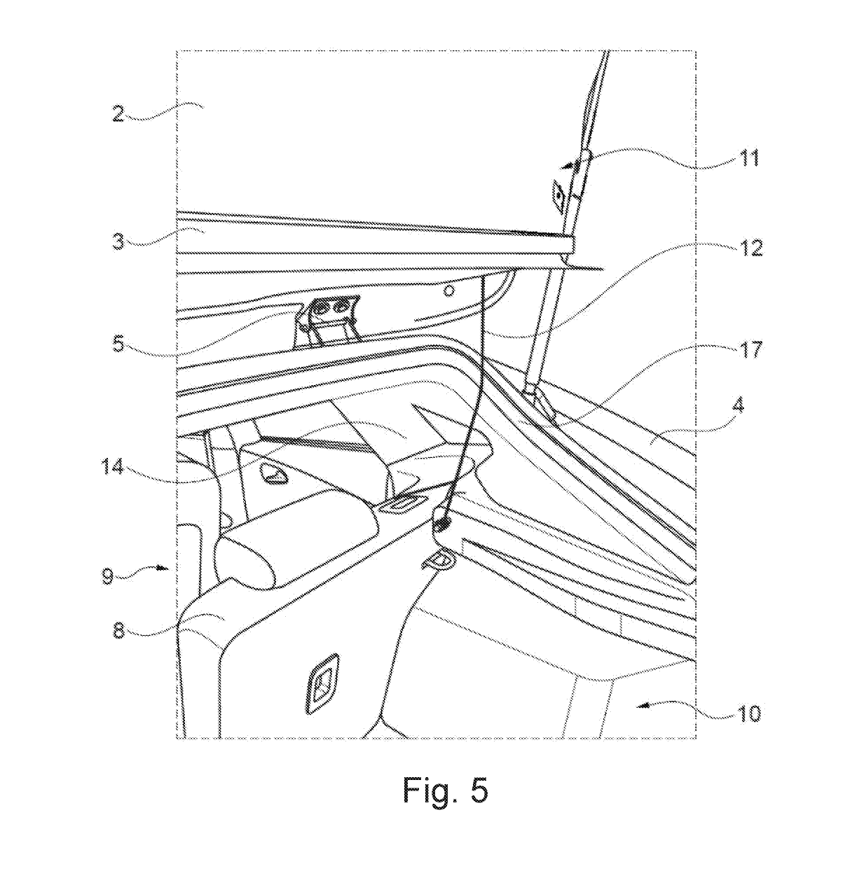

FIG. 4 illustrates a lateral inner view of the right vehicle side of the motor vehicle 16 from FIG. 3 with the tailgate 3 closed. It can be clearly seen that the force transmission feature 12 is attached at one end to the front end region 11 of the luggage compartment cover 2 and is fastened at the other end to the vehicle body 4. However, in the exemplary embodiment of the motor vehicle 16 that is illustrated here, the vehicle body-side attachment of the force transmission feature 12 occurs at a D-pillar 17 of the motor vehicle 1 that is arranged directly upstream of the tailgate 3, as can also be seen in FIG. 5 which illustrates a detail view of the rear-side right region of the motor vehicle 16 from FIG. 3 with the tailgate 3 opened and with the C pillar 14 of the motor vehicle 16 visible.

It can further be clearly gathered from FIGS. 4 and 5 that, in the illustrated exemplary embodiment of the motor vehicle 16, the force transmission feature 12 and the force deflection feature 15 are arranged in the passenger compartment 9 and are also accessible therefrom.

With particular preference, the luggage compartment cover 2 is releasably fastened to the tailgate 3 and the force transmission feature 12 is releasably fastened to the luggage compartment cover 2 and/or releasably fastened to the vehicle body 4.

The above-described motor vehicle is not limited to the embodiments disclosed herein but also encompasses further embodiments which have the same effect.

What is claimed:

1. A motor vehicle, comprising a tailgate that is pivoted up rearward and to which a luggage compartment cover is fastened so as to be pivotable by a rear end region about a pivot axis, the luggage compartment cover being held, at a region spaced from the pivot axis on a vehicle body by at least one force transmission feature that, upon pivoting up of the tailgate, pivots the luggage compartment cover so as to free access to a luggage compartment, wherein the force transmission feature is deflected on a force deflection feature mounted on the tailgate.

2. The motor vehicle as claimed in claim 1, wherein the region of the luggage compartment cover that is spaced from the pivot axis and at which the force transmission feature is attached is a front end region of the luggage compartment cover.

3. The motor vehicle as claimed in claim 2, wherein a vehicle body-side attachment of the force transmission feature occurs at a vehicle pillar arranged upstream of the tailgate.

4. The motor vehicle as claimed in claim 3, wherein the force transmission feature and the force deflection feature are arranged in a passenger compartment.

5. The motor vehicle as claimed in claim 4, wherein the force transmission feature is nonelastic in a force transmission direction.

6. The motor vehicle as claimed in claim 5, wherein the force transmission feature transmits only tensile forces.

7. The motor vehicle as claimed in claim 6, wherein the force transmission feature is a cable.

8. The motor vehicle as claimed in claim 7, wherein the force deflection feature is an eye.

9. The motor vehicle as claimed in claim 7, wherein the force deflection feature is a deflection roller.

10. The motor vehicle as claimed in claim 7, wherein there is respectively provided on each vehicle side of the luggage compartment cover the force transmission feature that is attached to said luggage compartment cover and which is deflected in each case via the force deflection feature mounted laterally on the tailgate.

11. The motor vehicle as claimed in claim 10, wherein the luggage compartment cover is releasably fastened to the tailgate and the force transmission feature is releasably fastened to the luggage compartment cover and/or is releasably fastened to the vehicle body.
